(19) United States
(12) Patent Application Publication
(10) Pub. No.: US 2007/0203787 A1
(43) Pub. Date: Aug. 30, 2007

(54) Retail facility

(76) Inventors: Raphael Keller-Go, Brookline, MA (US); Nancy Keller-Go, Brookline, MA (US); Lisa Foster, Providence, RI (US); John Horner, Somerville, MA (US); Paul Petrofsky, New Salem, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/518,399

(22) Filed: Sep. 8, 2006

Related U.S. Application Data
(60) Provisional application No. 60/715,985, filed on Sep. 9, 2005.

(51) Int. Cl. H04M 3/51; G06F 11/34

(52) U.S. Cl. 705/11; 705/1

(57) ABSTRACT

A retail facility employs various devices, equipment, techniques and methods that are well suited for the retail merchandising of bottled beverages, such as wine and liquors, but may be applied to other products as well, such as clothing, footwear, food items, tools, luggage, office supplies, toys, sporting goods, computer products, and recorded music or video products.

### RELATED APPLICATIONS

This application claims priority under 35 U.S.C. §119(e) to U.S. Provisional Application Ser. No. 60/715,985, entitled “RETAIL FACILITY” filed on Sep. 9, 2005, which is herein incorporated by reference in its entirety.

### FIELD OF THE INVENTION

The devices and methods described herein relate to retail facilities for the sale of merchandise.

### BACKGROUND

Problems that confront retail facilities include the efficient use of retail space and providing information about products to purchasers.

### SUMMARY OF INVENTION

Various aspects of the physical structure and operation of retail facilities are described herein.

The devices, equipment, techniques and methods described herein may be used in the merchandising of a variety of products. These devices, equipment, techniques and methods are well suited for the retail merchandising of bottled beverages, such as wine and liquors, but may be applied to other products as well, such as clothing, footwear, food items, tools, luggage, office supplies, toys, sporting goods, computer products, and recorded music or video products.

In one aspect, the features described herein relate to display structures (such as shelving, racks, or cabinets) for displaying products.

In another aspect the features described herein relate to documents (in, e.g., printed or electronic form) for describing merchandise.

In another aspect, the features described herein relate to indicia (e.g., identification cards, gift cards, passwords, barcodes, electronic media) of a particular customer, customer purchase history, customer account, and/or store credit.

In another aspect, the features described herein relate to labels, signage, cards, placards and the like that contain indicia of a particular retail facility.

In another aspect, the features described herein relate to the use of any of the devices and/or methods described herein in the operation of retail merchandise facility.

### BRIEF DESCRIPTION OF DRAWINGS

FIG. 1 is an exterior view of a retail facility.

FIGS. 2-14 are perspective views of the interior of a retail facility showing cabinetry used for displaying merchandise.

FIGS. 15-23 show front elevation, plan, and sectional views of cabinetry used for displaying merchandise.

FIGS. 24-26 is a printed take-home document that accompanies a purchase of an item at a retail facility.

FIG. 27 is a customer identification card.

FIG. 28 is an application for a customer identification card.

FIG. 29 is a gift card.

FIGS. 30-31 are advertising sheets relating to a retail facility.

FIG. 32 is a merchandise bag for containing a customer's item purchased from a retail facility.

FIGS. 33-36 are illustrations relating to in-store events at a retail facility.

### DETAILED DESCRIPTION

A retail facility, its devices, equipment, techniques and methods of operation are described herein. The facility described herein relates to a business named VINODIVINO, located in Newton, Mass., which is involved in the retail sale of wines and liquors. The devices, equipment, techniques and methods described herein are applicable to other categories of retail merchandise based on the description and disclosure herein.

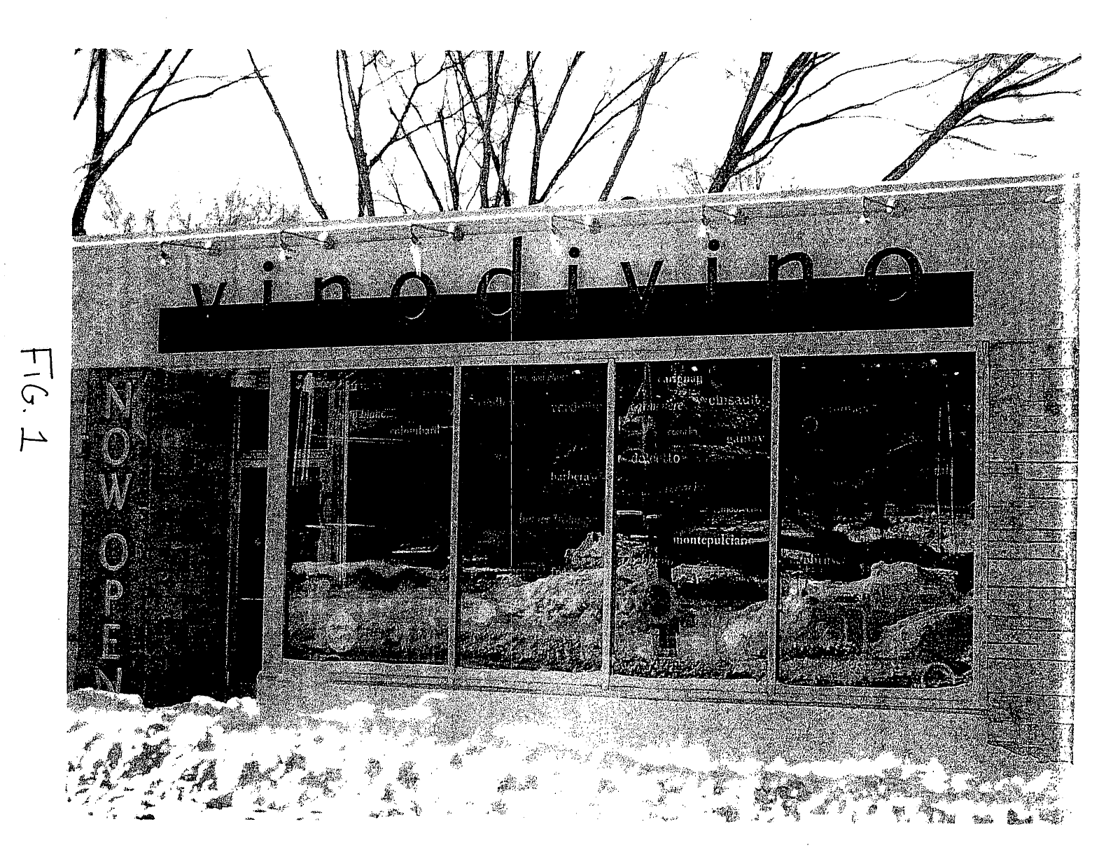

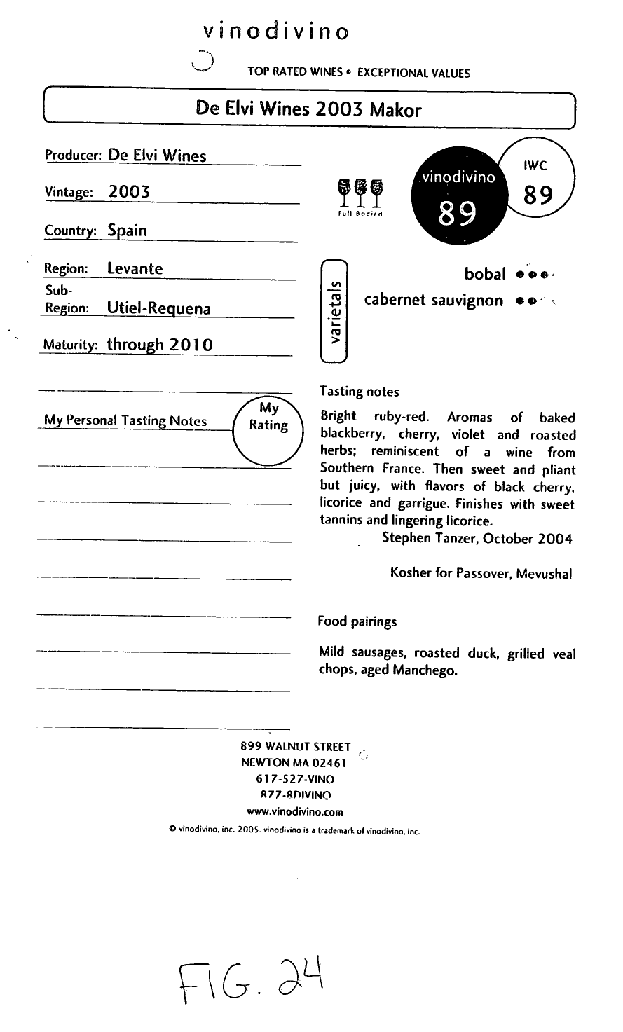

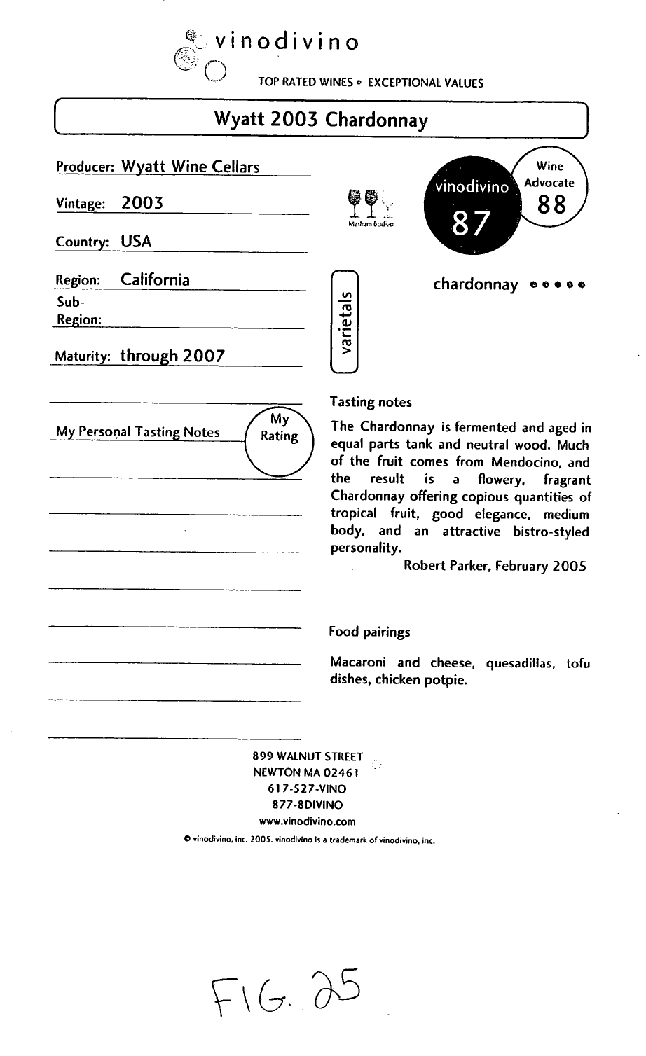

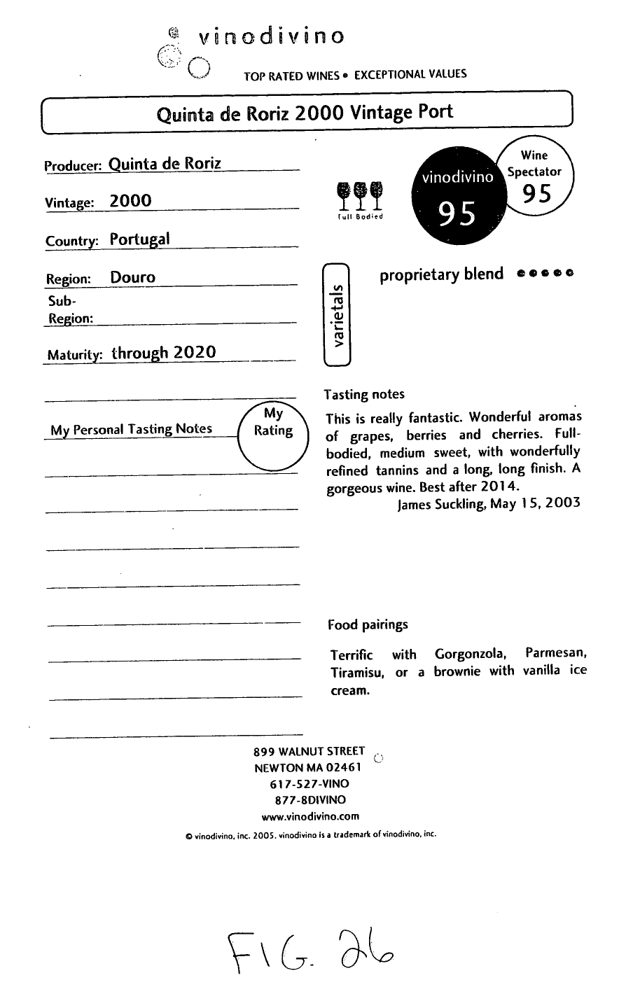

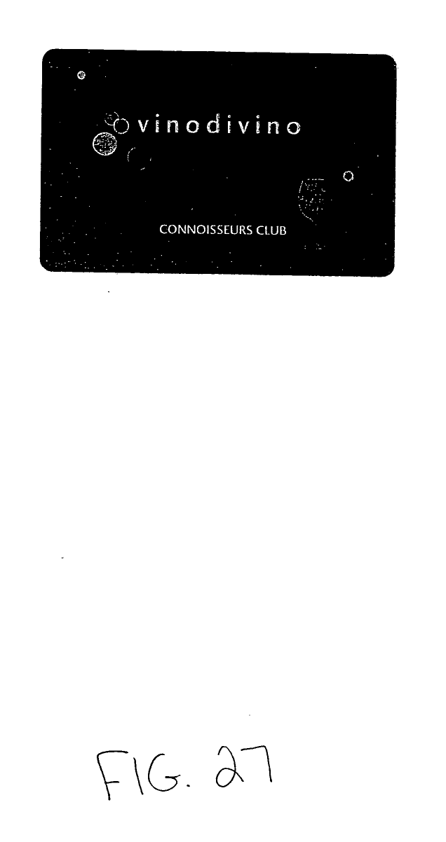

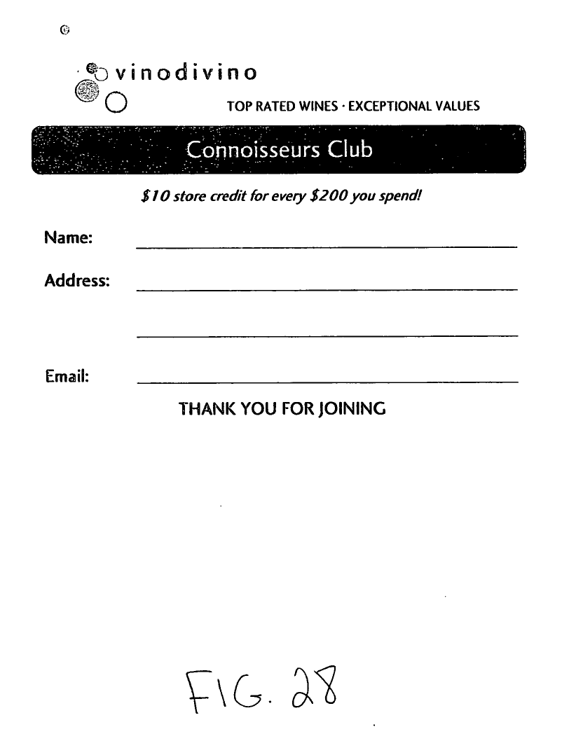

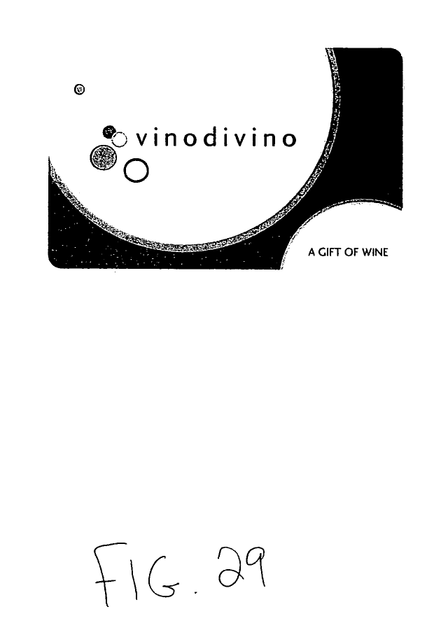

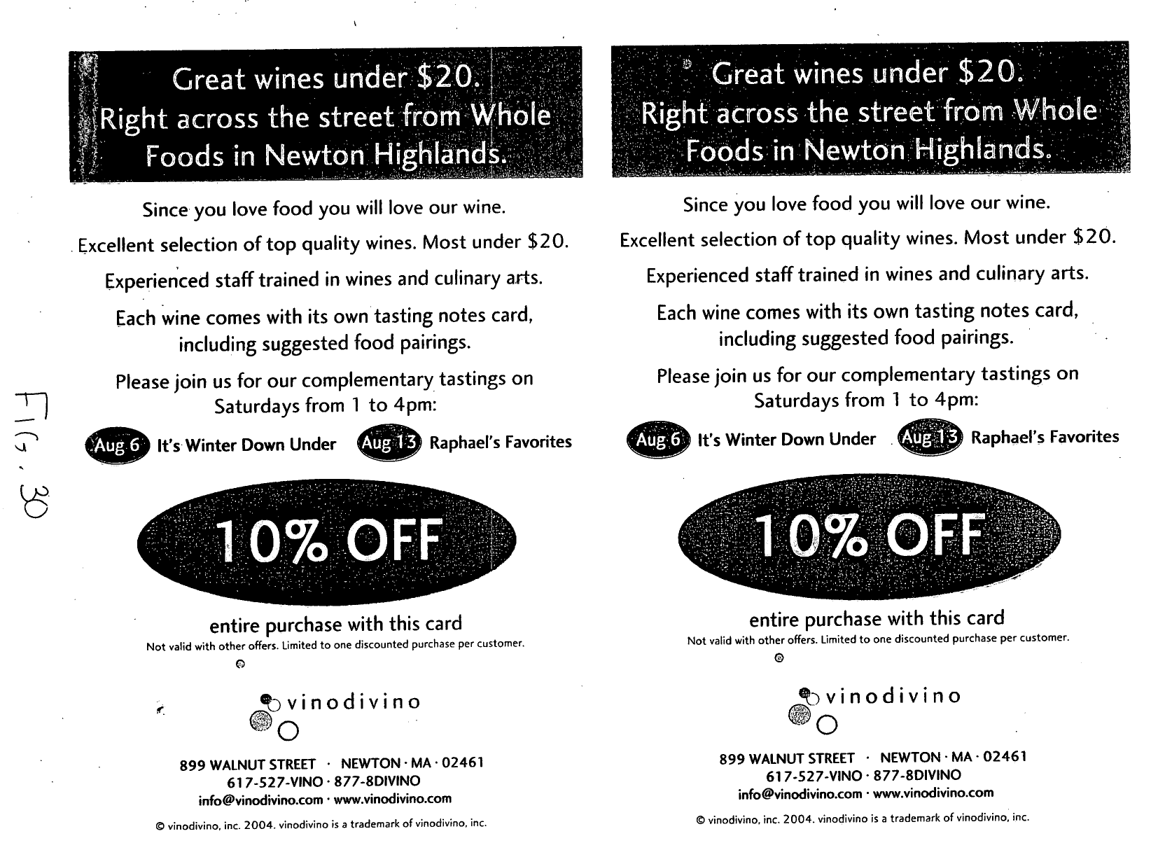

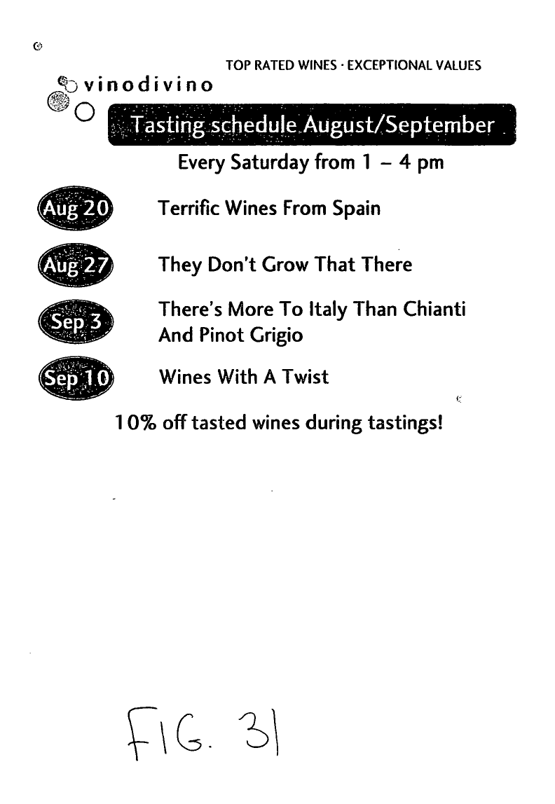

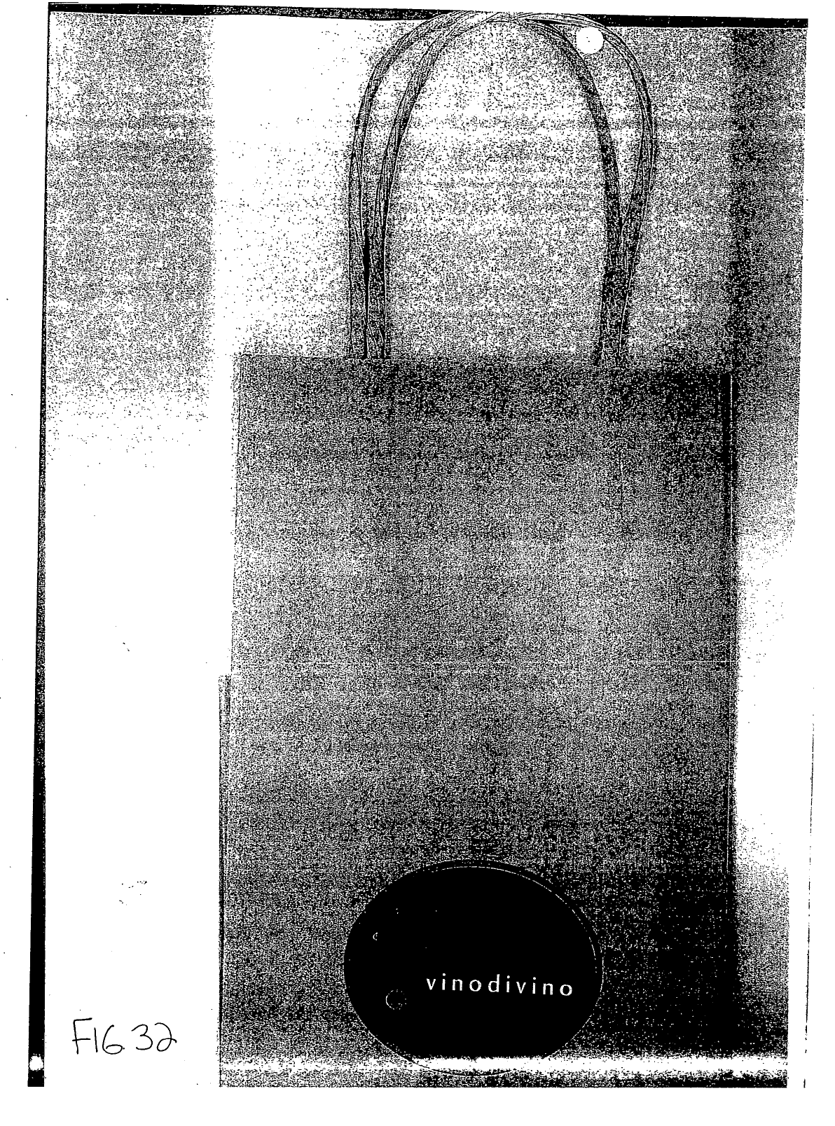

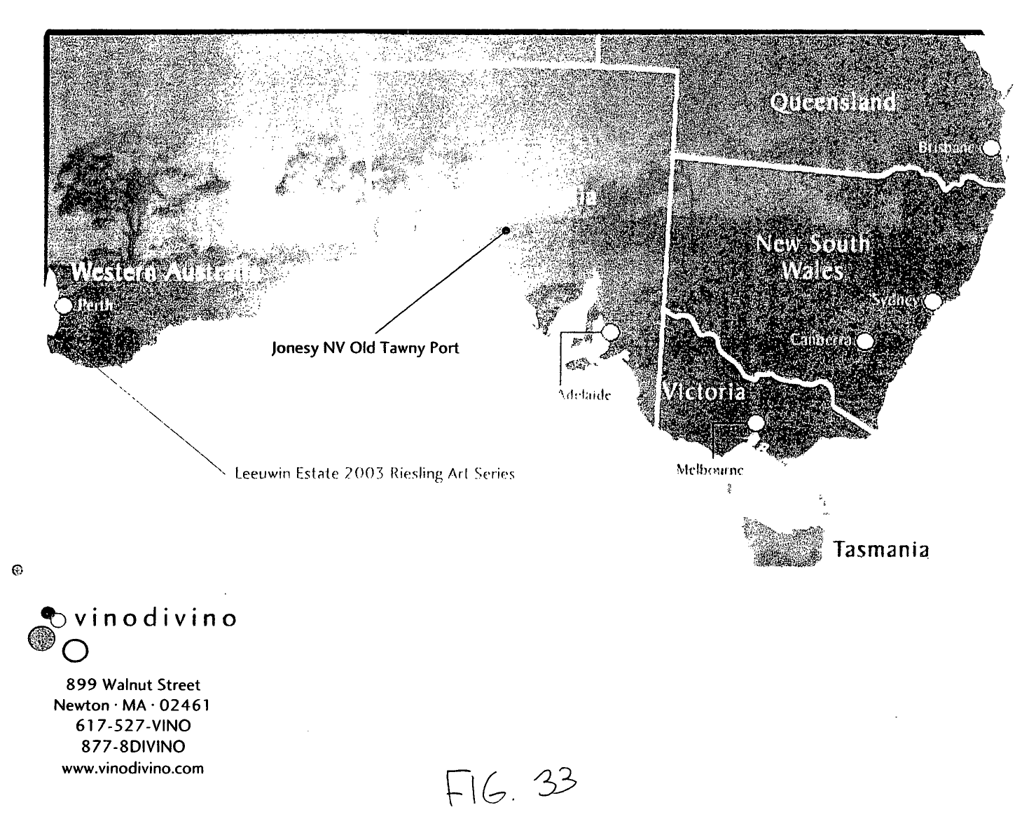

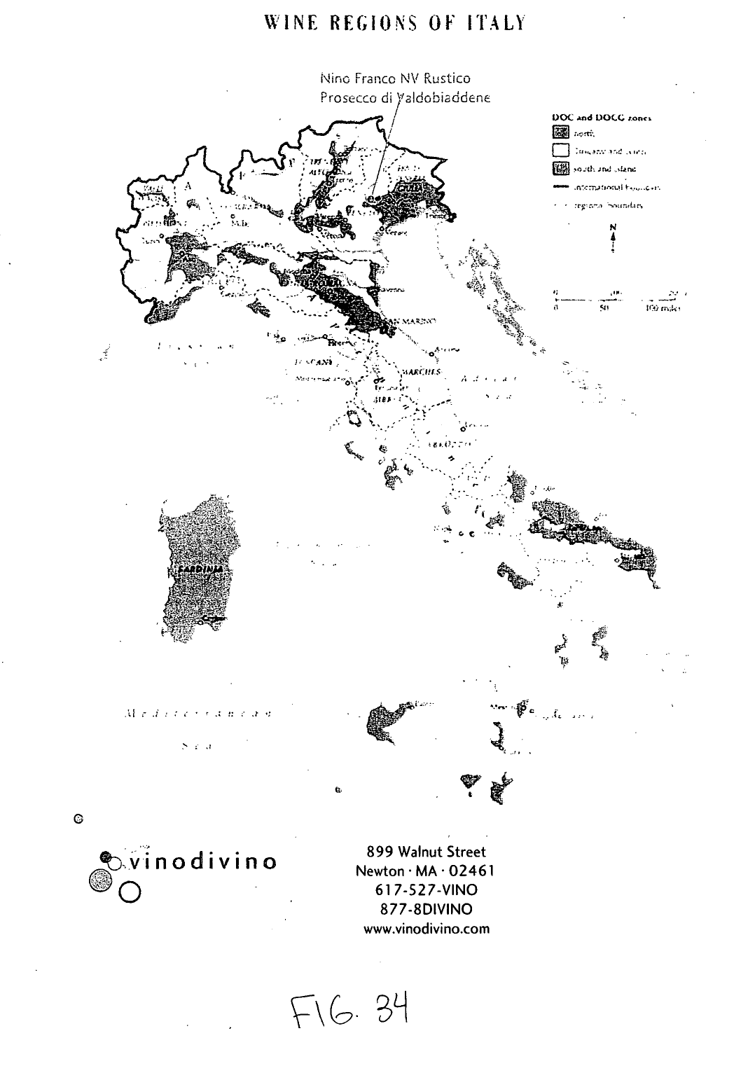

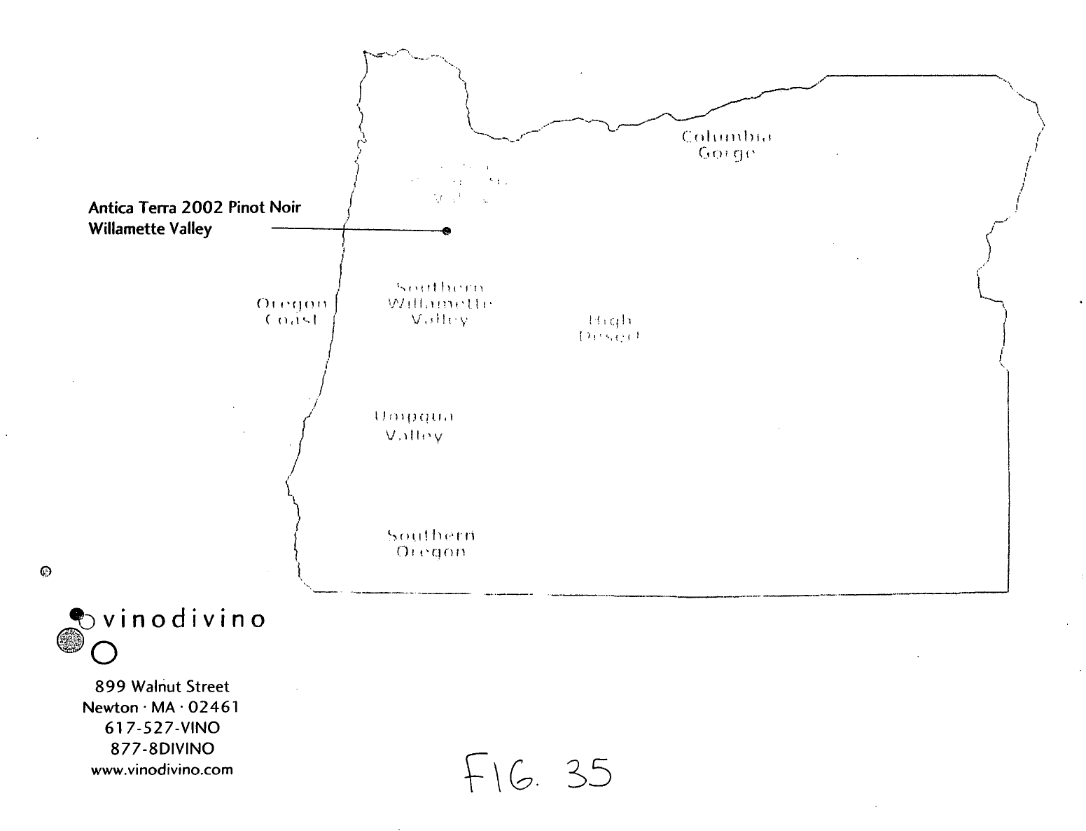

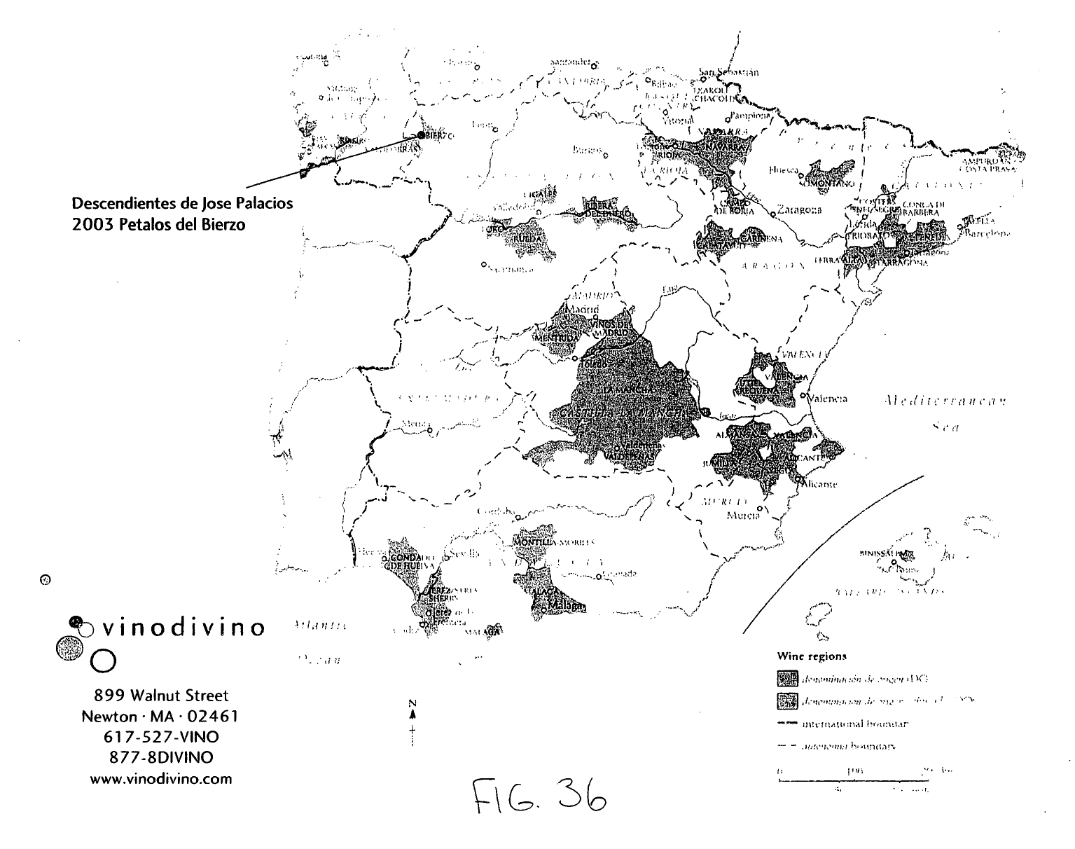

The exterior of the retail facility displays signage bearing the VINODIVINO name and design motif. The name and motif also appear on, for example, the business' publications, customer handouts, cards describing merchandise, mailings, emails to customers, and labels that appear on bags containing purchases. Examples of such items are shown in FIGS. 1, 24, 26-36.

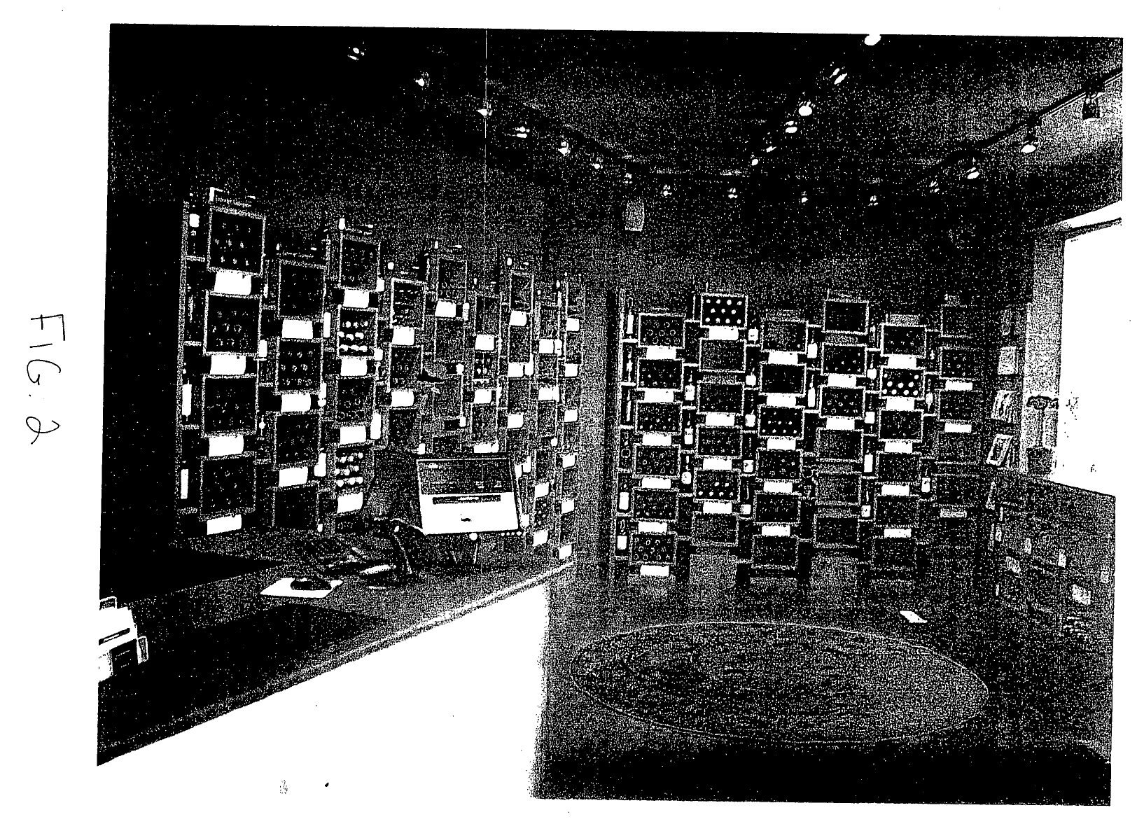

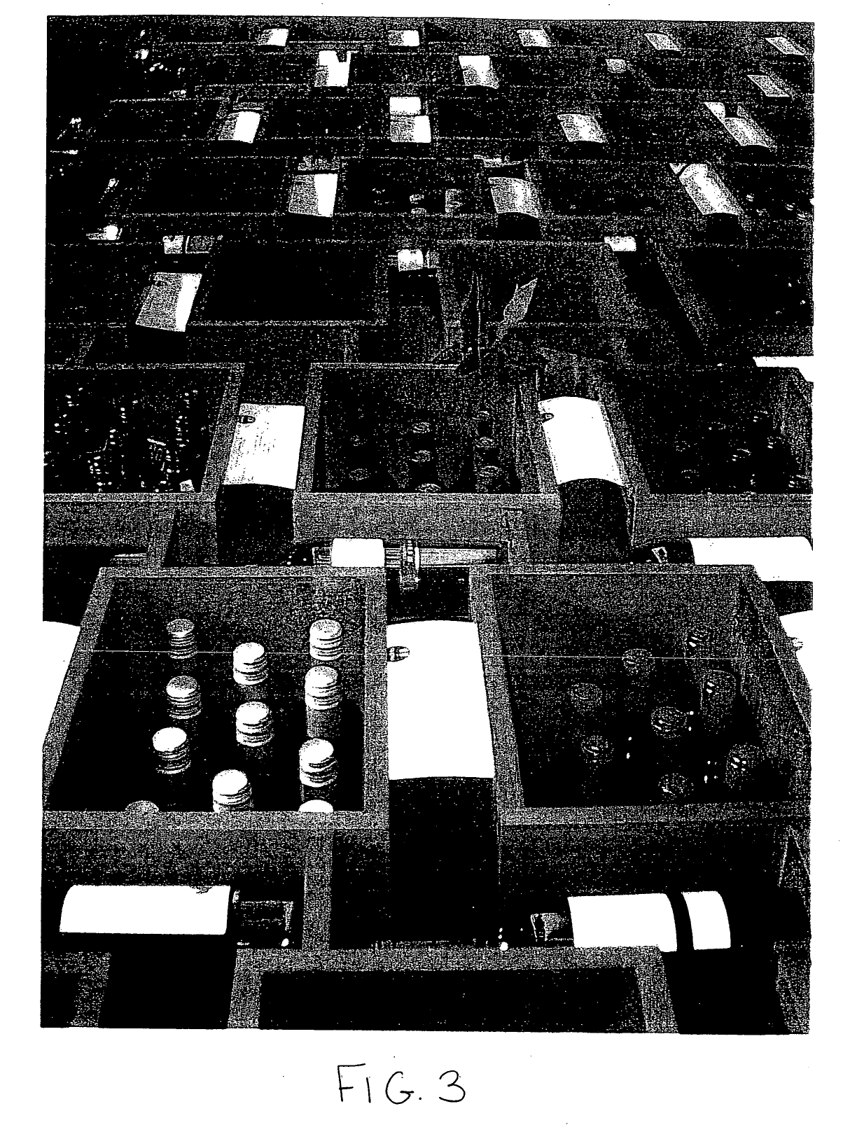

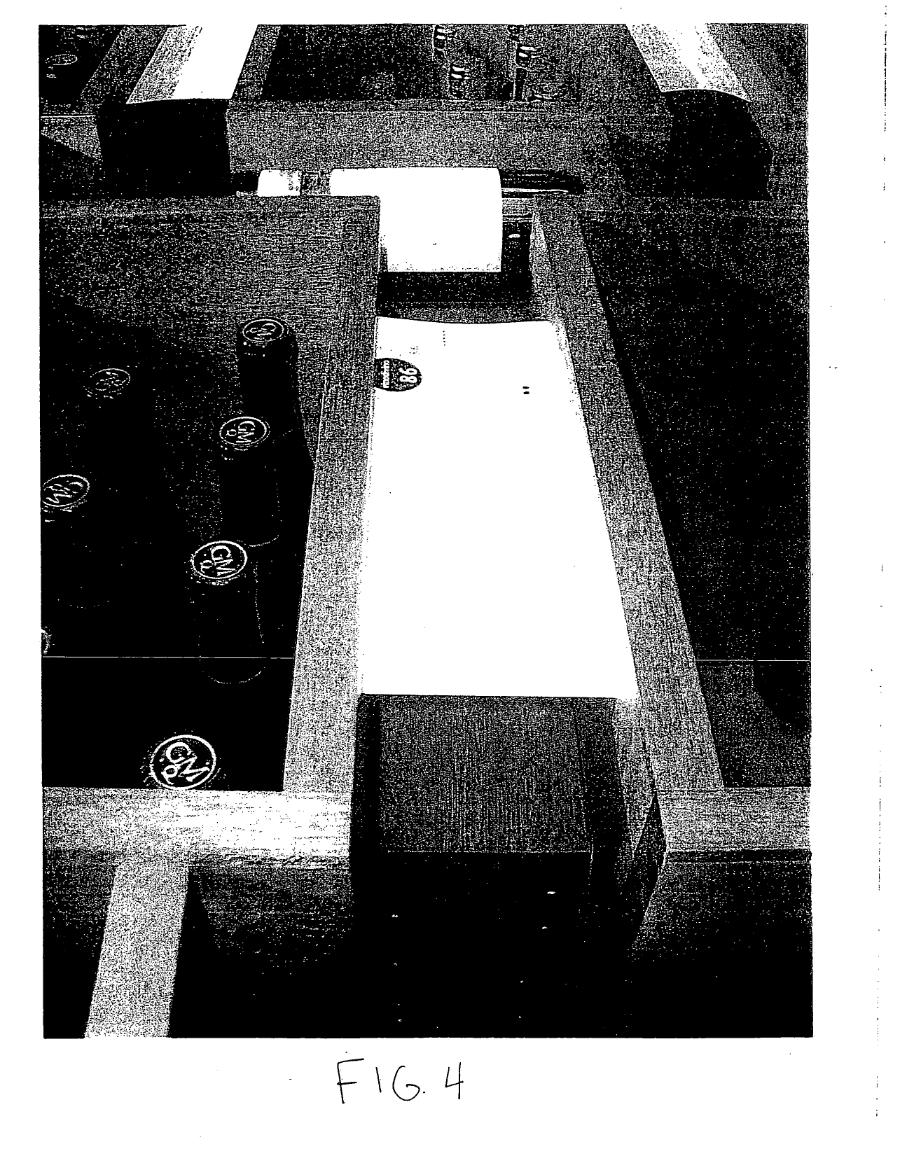

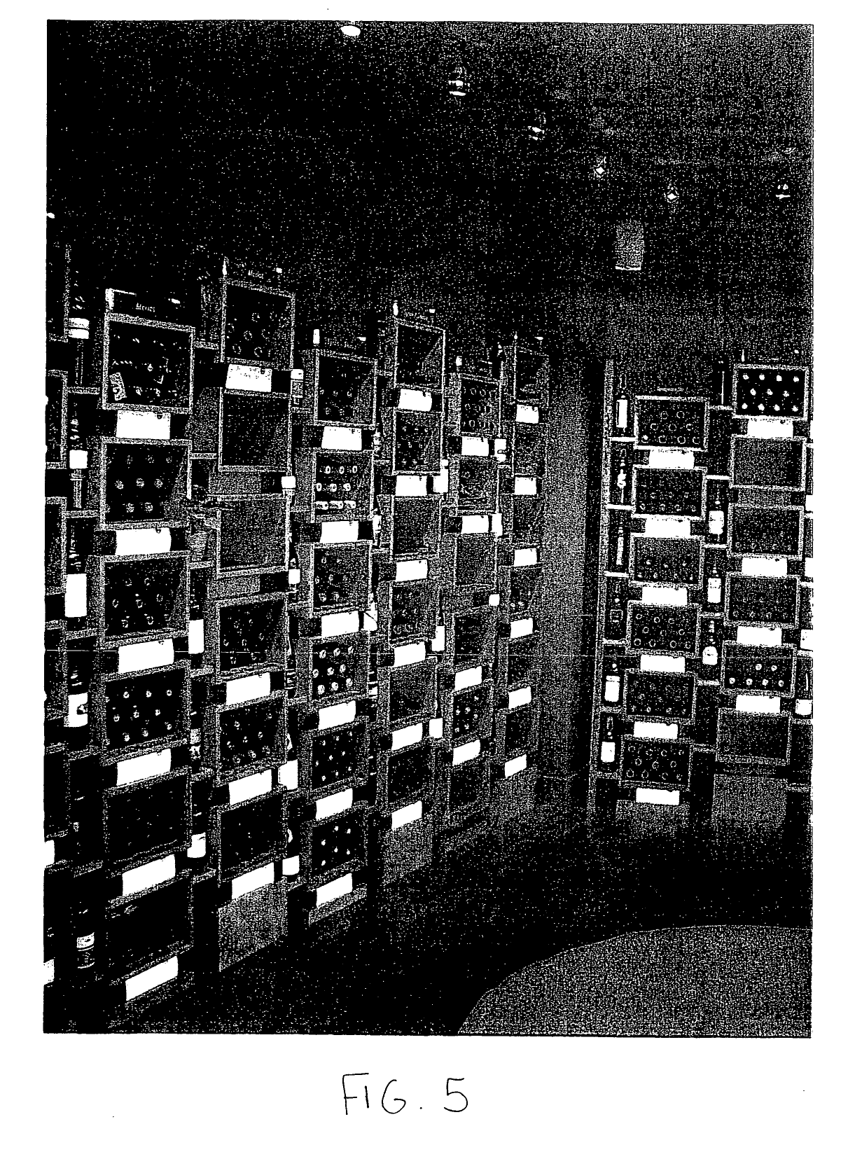

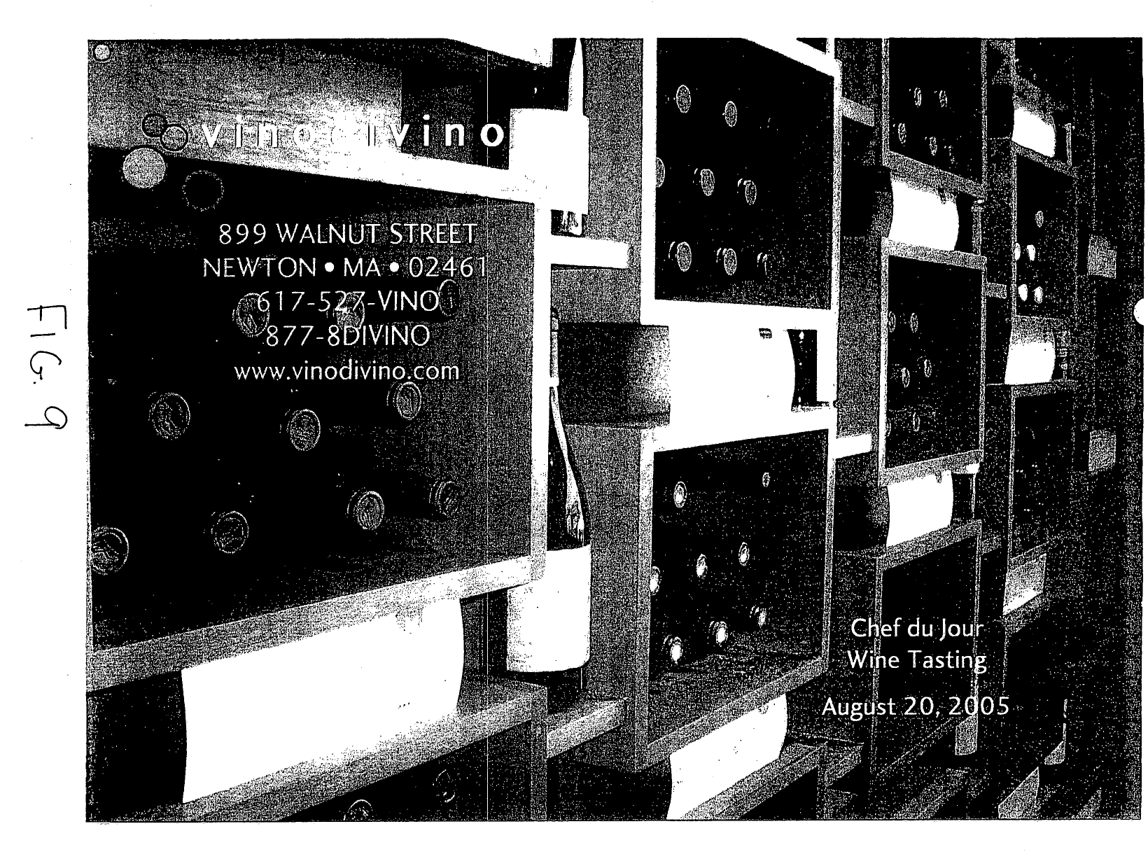

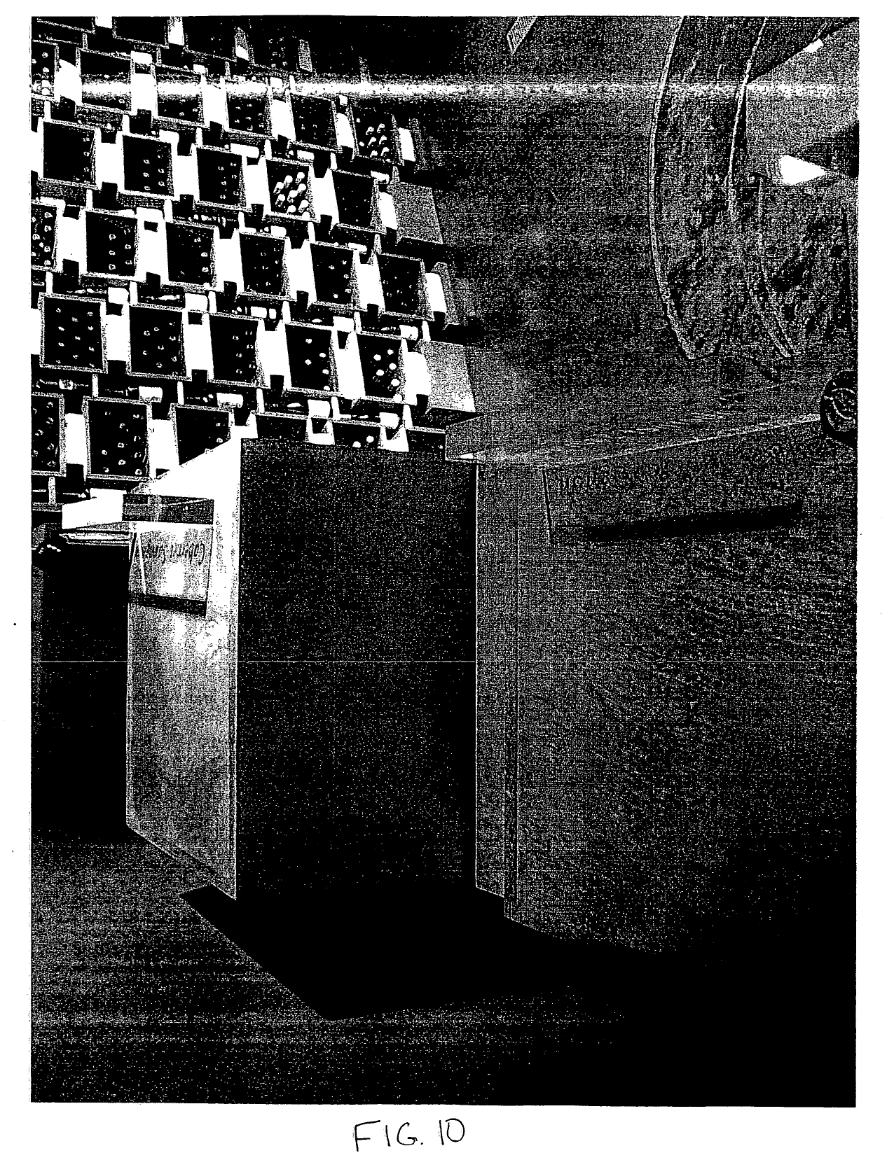

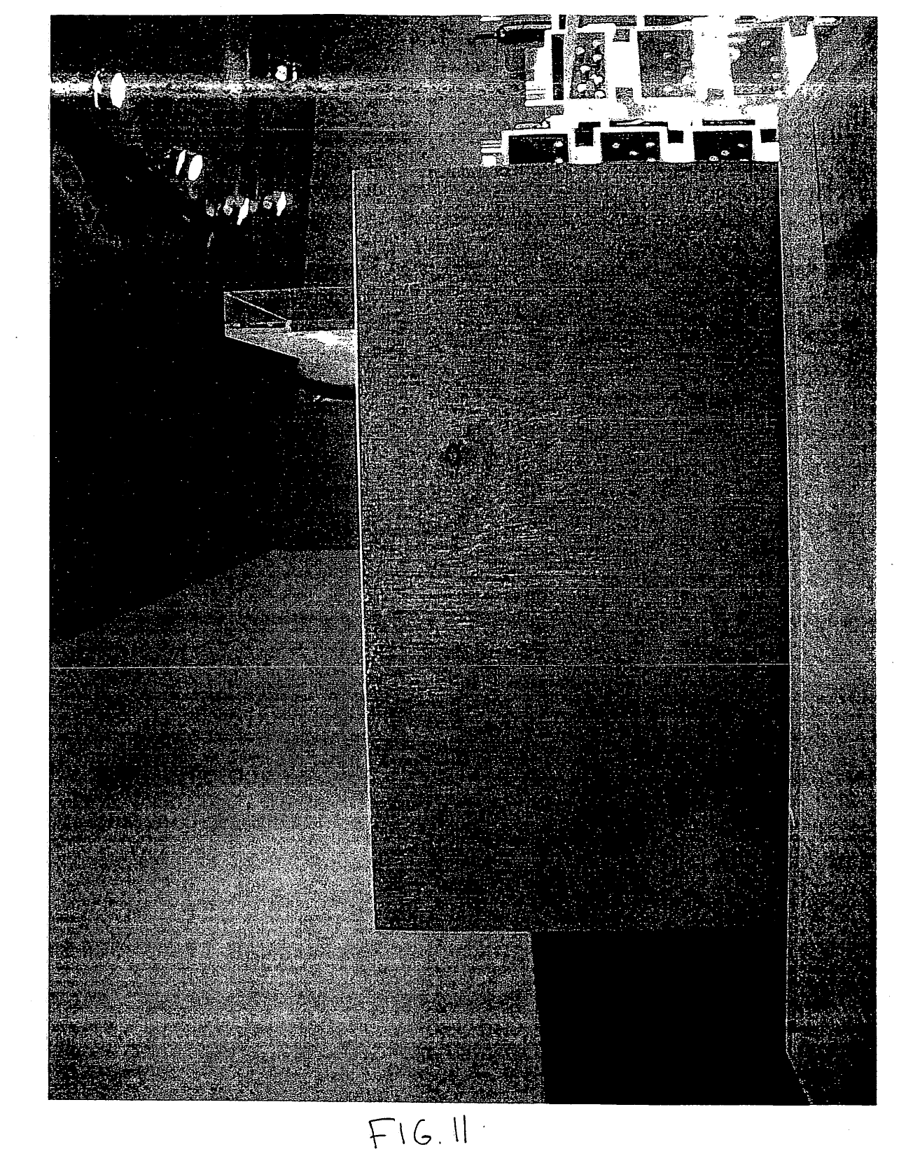

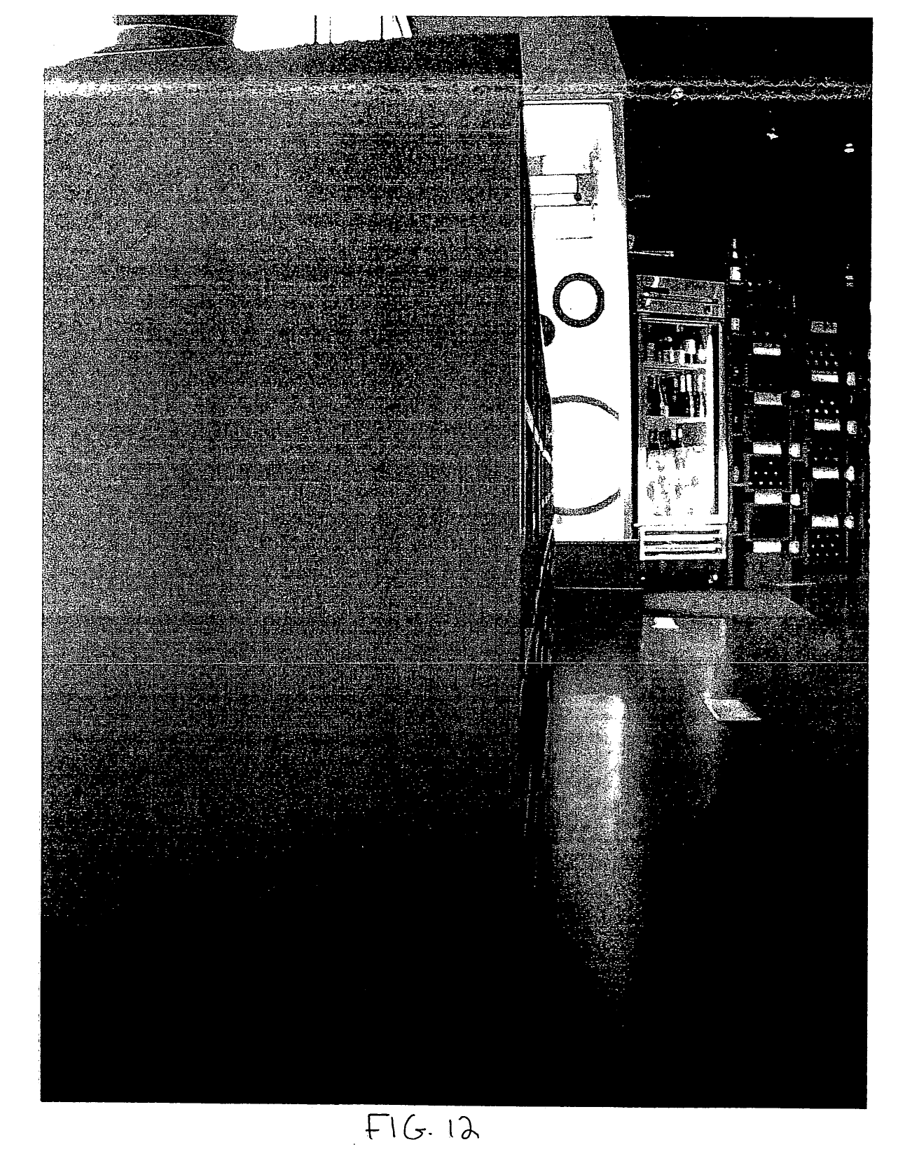

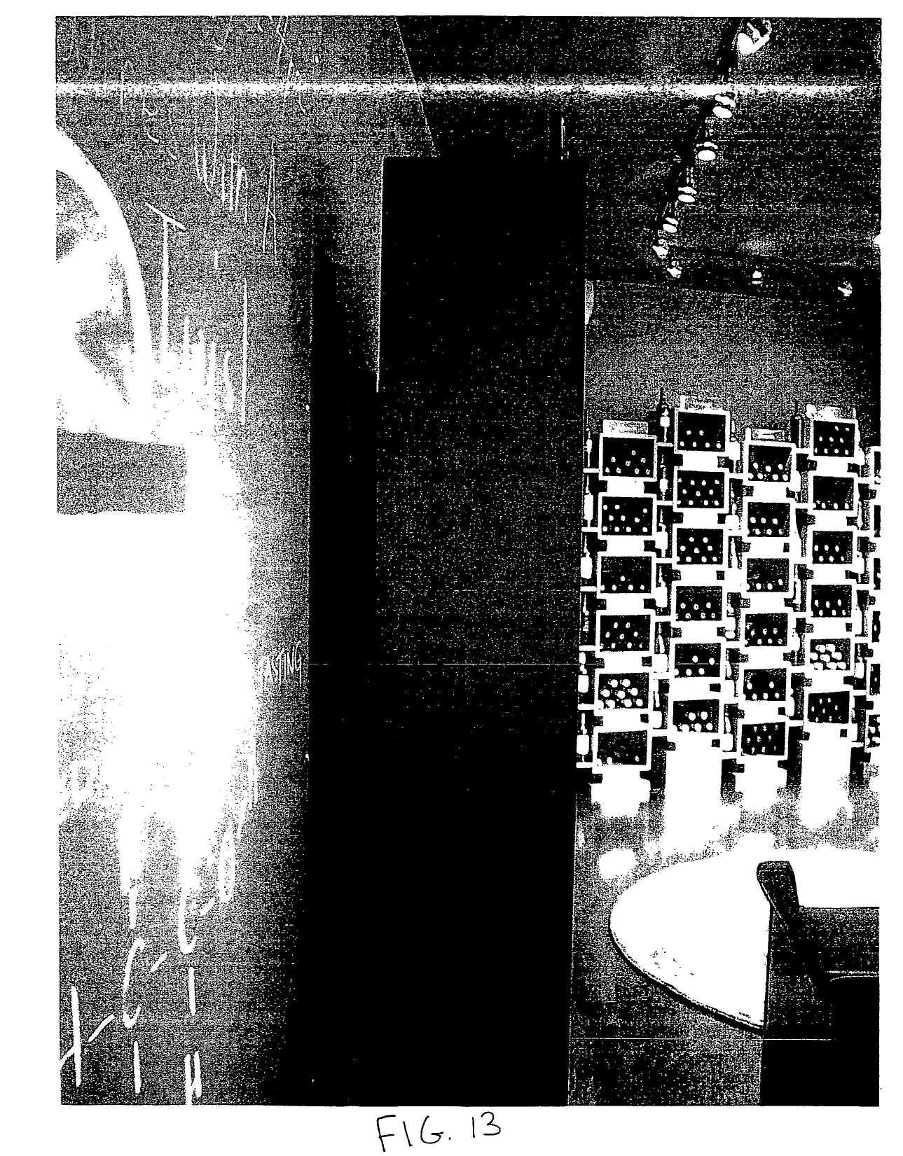

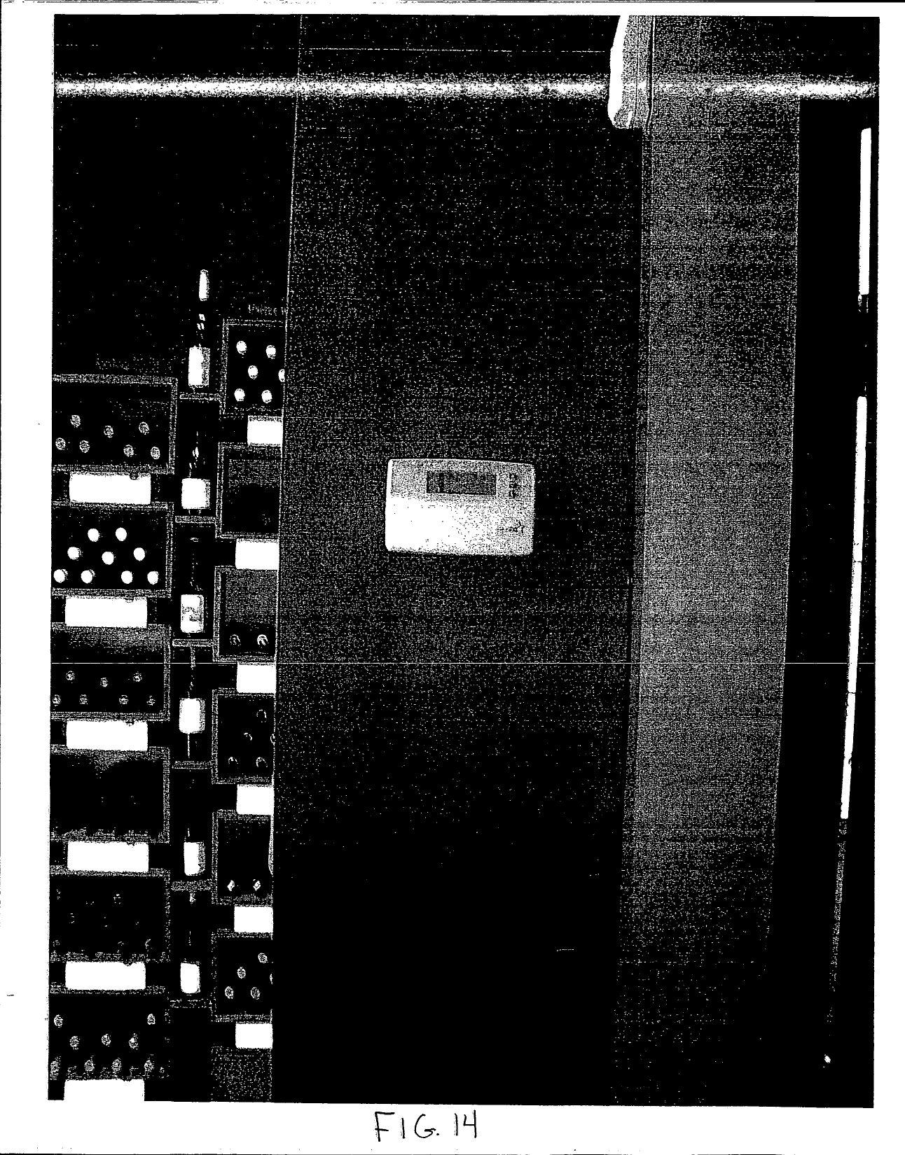

FIGS. 2-14 show the interior of the retail facility, including examples of inventive cabinetry. The cabinetry in these examples for holding the merchandise (bottles of wine) are set against the interior walls, thus leaving floor space open for in-store events, such as wine tasting events and discussions regarding particular types of wine.

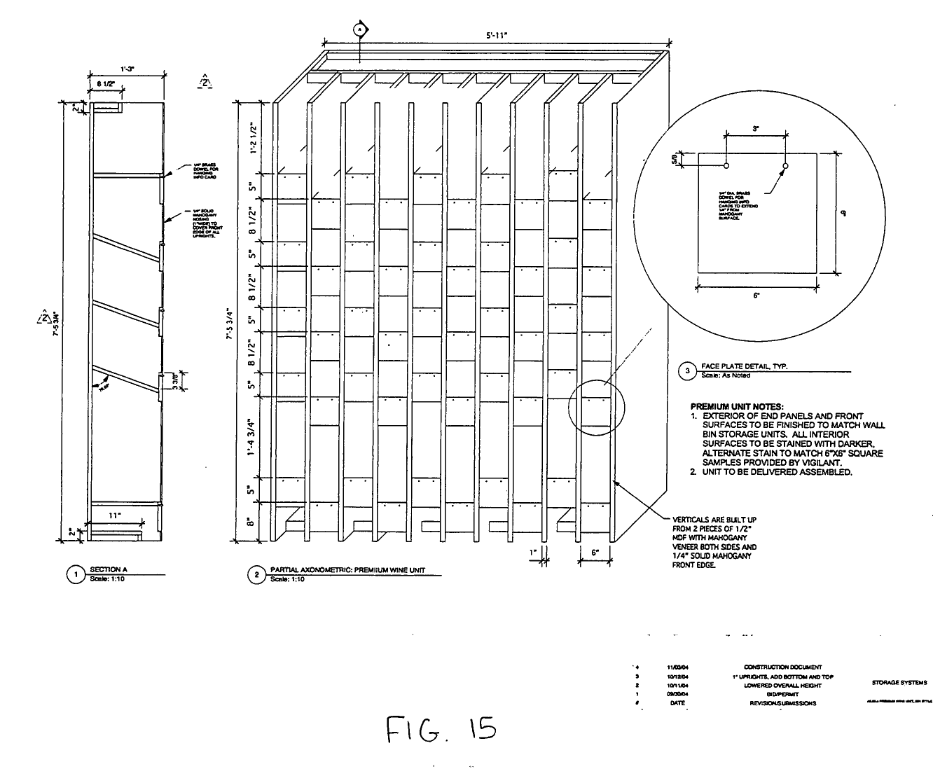

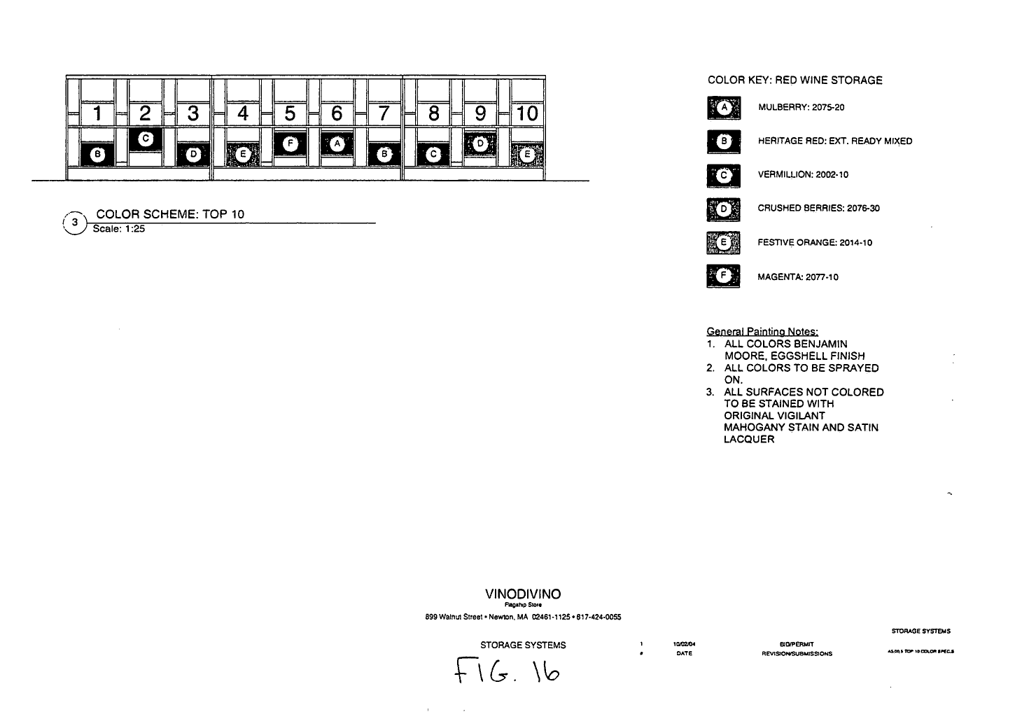

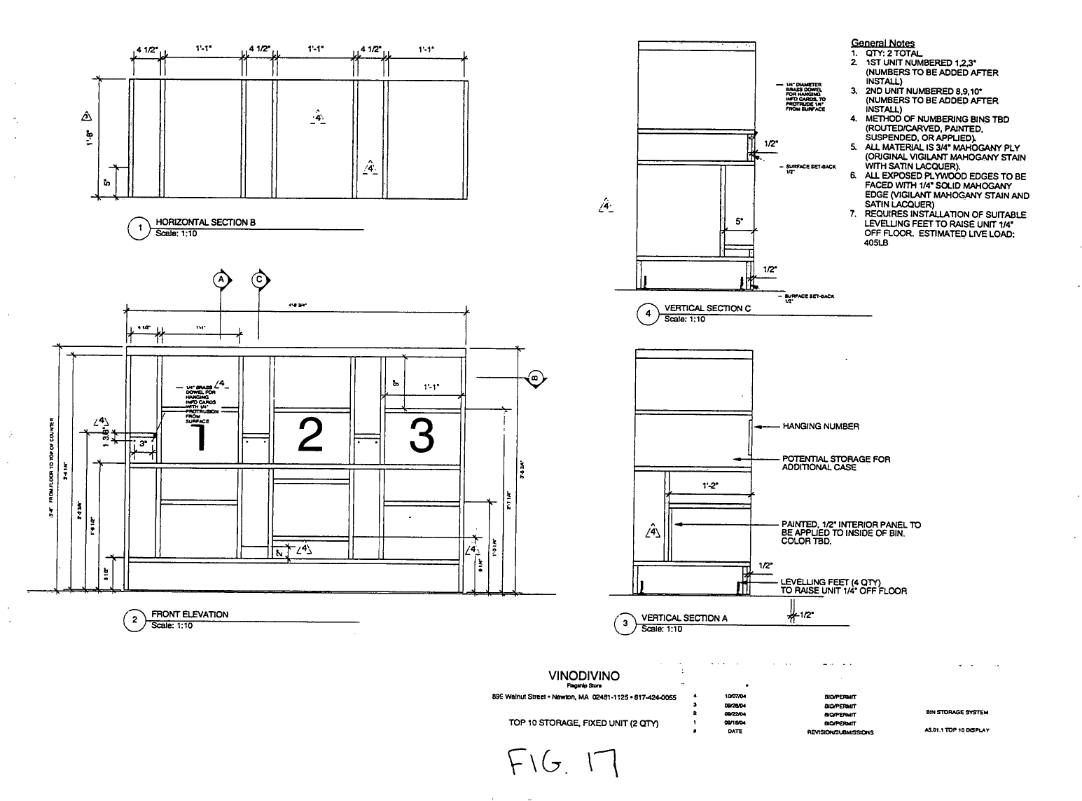

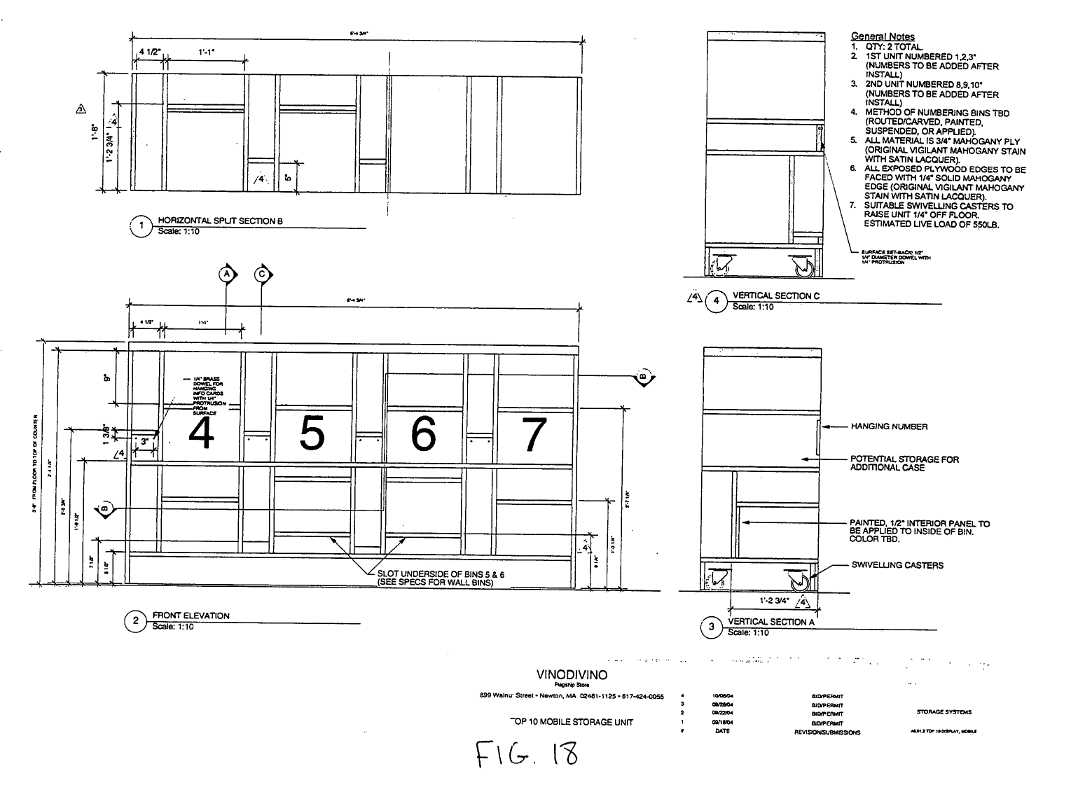

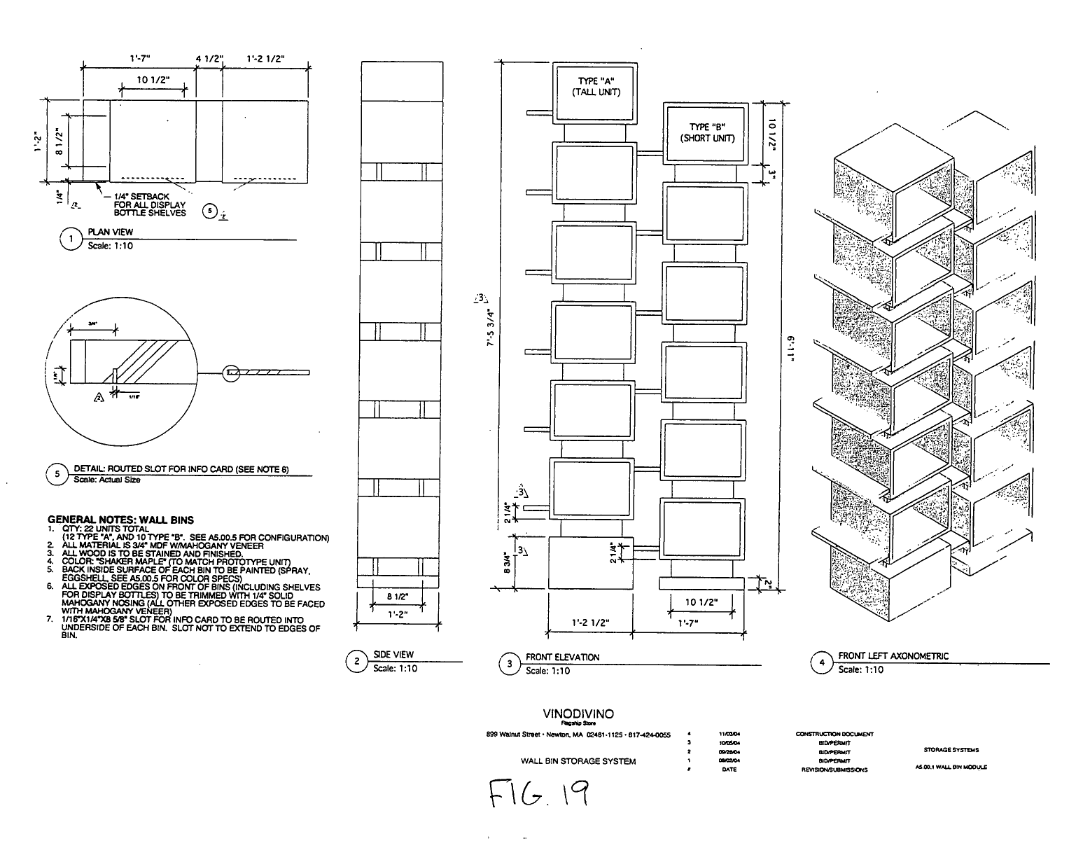

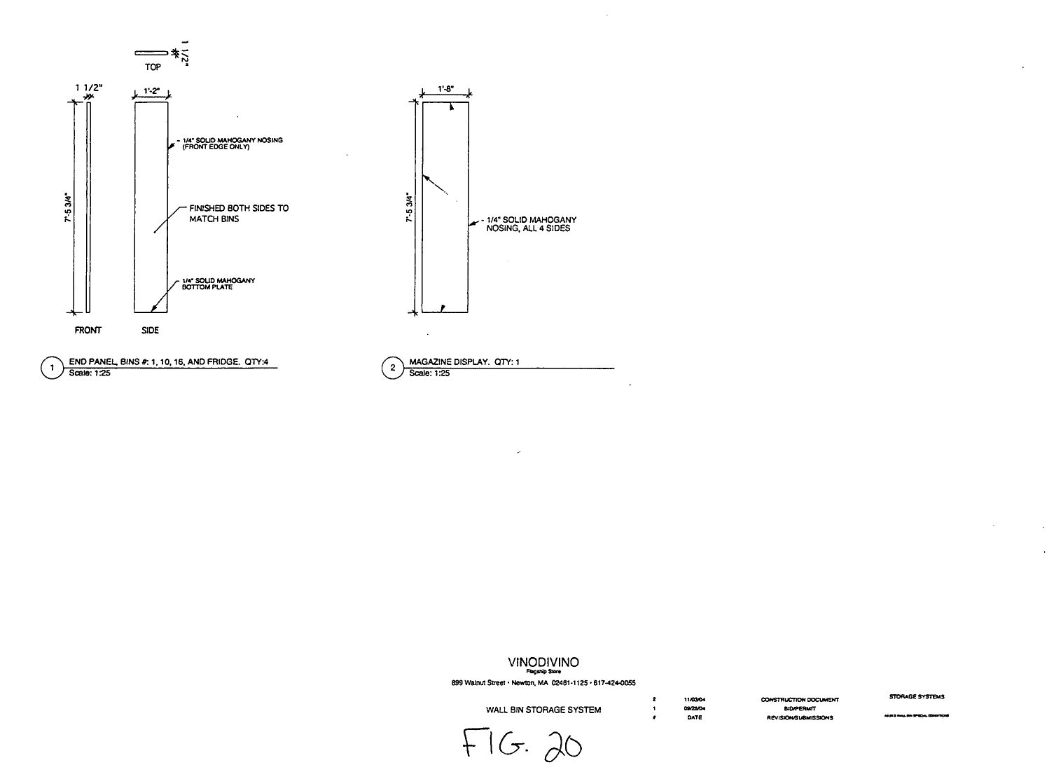

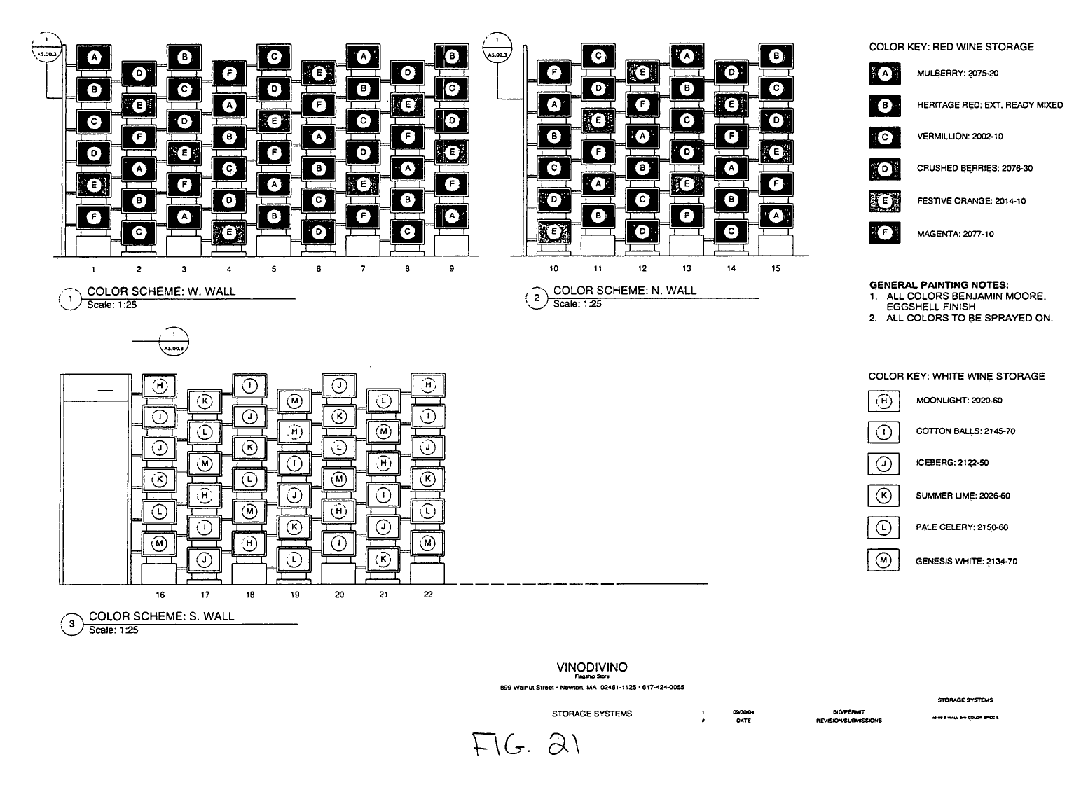

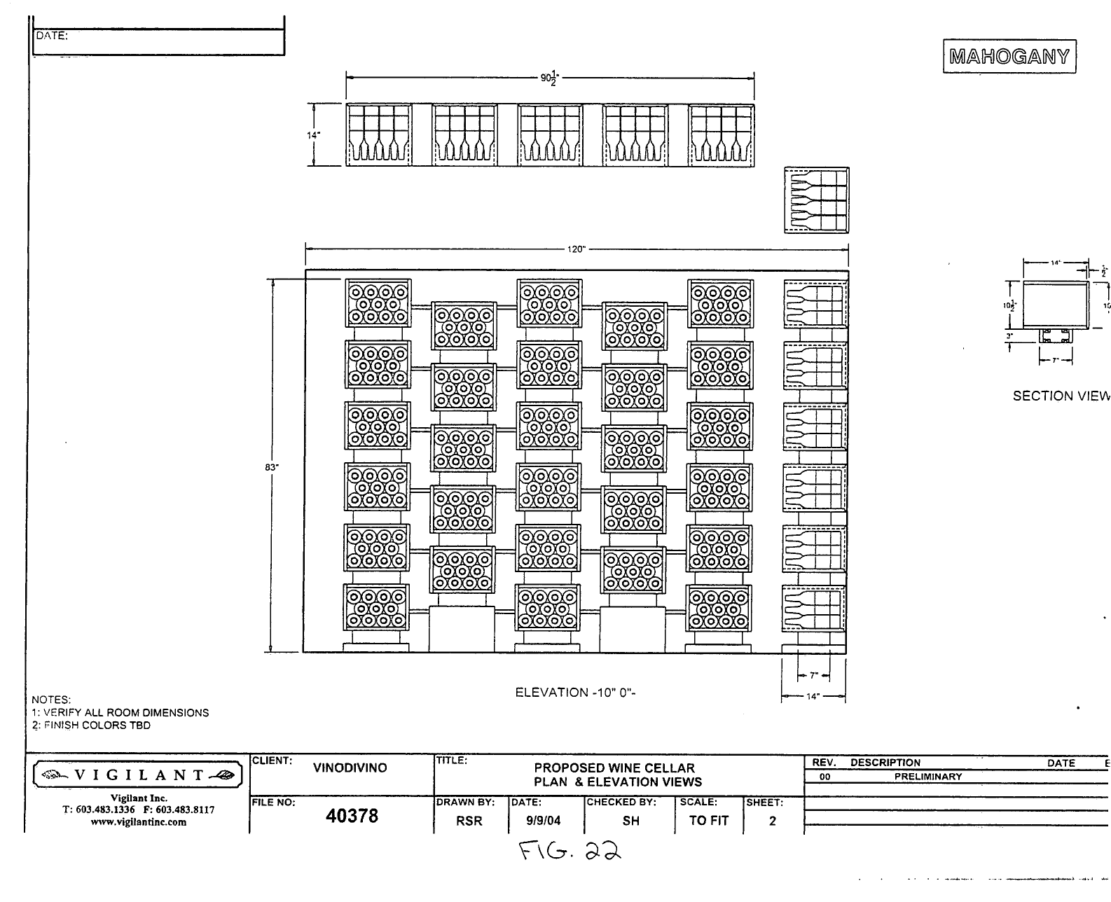

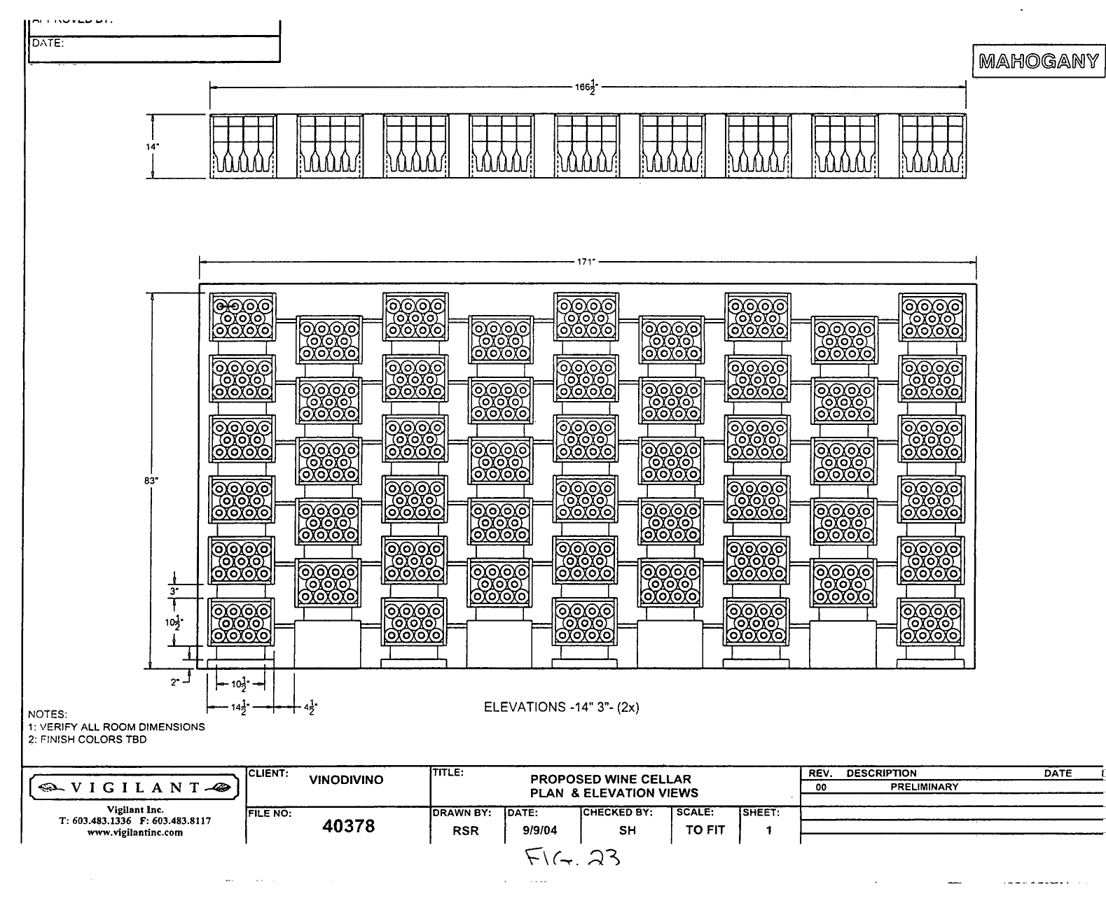

FIGS. 15-23 show the structure of examples of the types of cabinetry used.

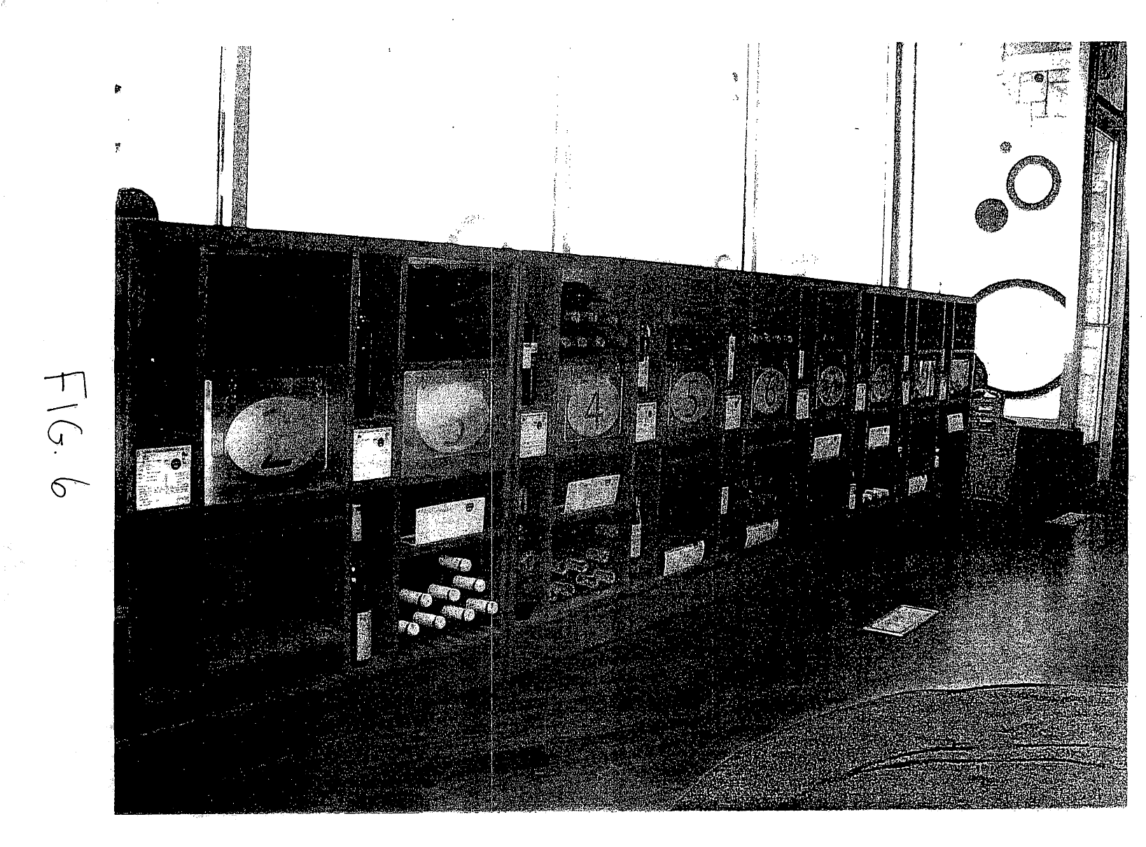

The wall-bins (FIGS. 15-23) employ off-set rows of rectangular receptacles. The receptacles in these examples are sized to accommodate wine bottles in an efficiently stacked pattern. For example, rectangular receptacles may be sized to fit a bottom row of four bottles oriented horizontally and set perpendicularly to the back of the cabinet, then a middle row of three bottles set into the interstitial regions formed by the bottom row of bottles, and a third row of four bottles—two of which are set into the interstitial regions formed by the middle row of bottles and two of which are braced against the outer bottles of the middle row and the interior sides of the receptacle. While these are rectangular, one of skill in the art may apply this principle to other areas, although the application to wine bottled is unique and unusual. The off-set arrangement of the receptacles defines spaces (next to the receptacles) where a wine bottle may stand vertically on its bottom on a shelf formed by the cabinet. The vertical bottle may be of the same type as the bottled wine stored in a contiguous receptacle, thus showing the appearance of the wine bottles that are stacked horizontally (thus, more efficiently) nearby. Further, in this example, the receptacles are spaced from each other (in rows) so that beneath each receptacle, there is a region sized for receiving a card containing information about the wine stored in the receptacle next to it (either below or, preferably, above). A similar type of cabinet, shown in FIG. 6, does not use the same off-set arrangement of receptacles, but employs rectangular receptacles (for horizontally arranges bottles) and shelf space for supporting an exemplary bottle next to each rectangular receptacle.

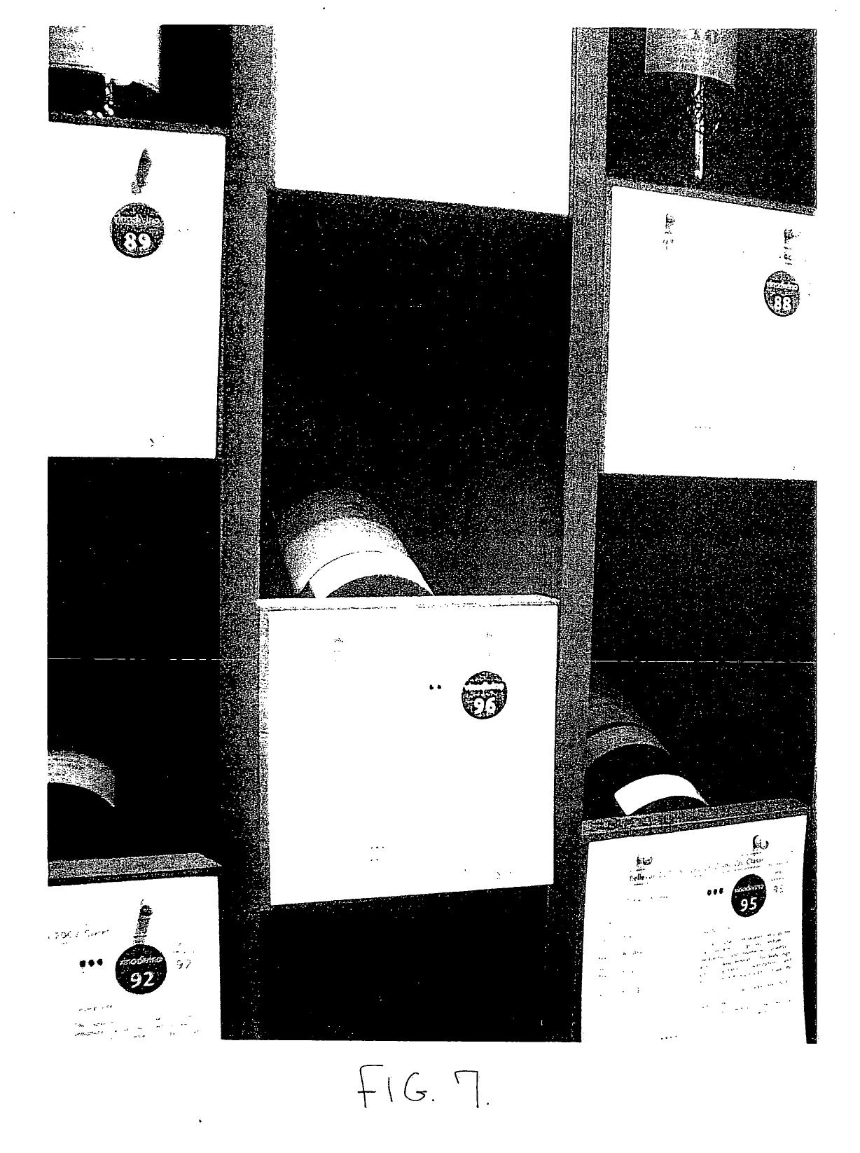

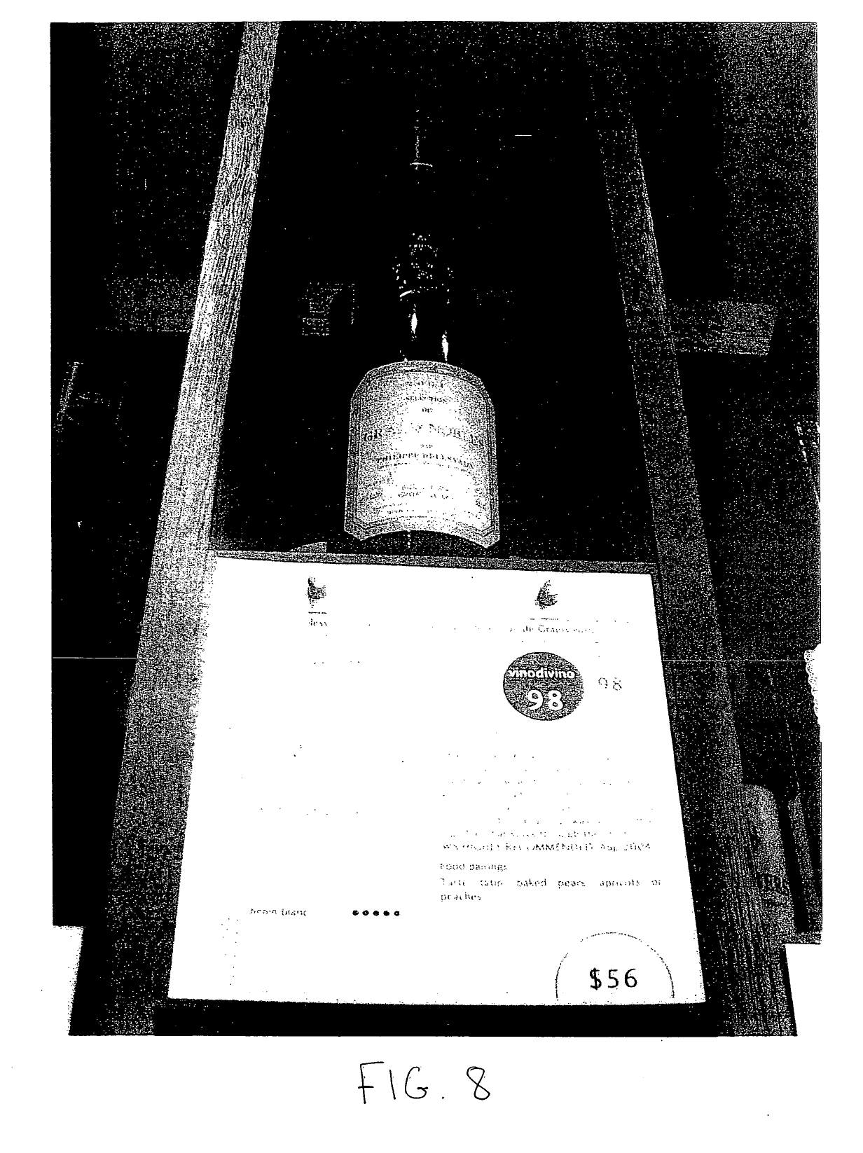

Another example of a cabinet (FIGS. 7 and 8), well-suited for premium bottled wines, in some aspects has several columns containing of receptacles for holding bottles. At the upper and lower ends of the columns (FIG. 7), the bottles are supported by the cabinet, so that they stand vertically on their bottoms. For bottles supported between the upper and lower ends of the cabinet, the bottles are supported at an angle (FIG. 8), relative to the openings in the cabinet facing outward, thus allowing a person in the retail facility to see these angled bottles at a relatively comfortable viewing angle. The use of angled presentation uses the space of the facility efficiently. Below each of the receptacles, there is a space sized to accommodate a card containing information about the wine stored in the receptacle above it.

The bottled wines stored in the cabinets may be arranged in any desired fashion in certain embodiments, with respect to wine categories or regions of origin, or any other quality. The cabinets may be provided with an exterior having a substantially uniform color, or they may be colored to indicate particular aspects of the bottled wines stored in the various receptacles, or for aesthetic purposes.

The cards providing information about the wines sold in the retail facility provide a numerical rating from a recognized authority or publication (e.g., Wine Spectator), as well as the rating provided by the staff of the retail facility itself. The card also may provide such information as the time frame the wine will mature, its place and/or region or origin, “Tasting Notes” (i.e., a commentary about the wine), and “Food Pairings” (i.e., food selections that are well-suited to the particular wine). Customers who buy bottles of wine may be given cards having a similar format, for each particular wine purchased at the retail facility. The cards may be stored by the respective wine bottles, or printed (or kept) at a counter and handed out at the place and/or time of purchase. In addition to the information that is also on the in-store cards, the customer take-home cards contain a field entitled “My Personal Tasting Notes” for the customer to provide personal comments about the wine, as well as a field entitled “My Rating” for the customer to provide a personal numerical rating. The take-home cards thus encourage customers to keep track of their preferred wines and to expand their understanding of wines. Customers may be further educated about activities at the retail facility and about wines, by, for example, emails, newsletters, mailings, and/or flyers.

The retail facility may also maintain a database of customer purchases. Each customer is invited to join the frequent-buyer program (the CONNOISSEURS CLUB). The retail facility keeps track of purchases made by each CONNOISSEURS CLUB member. Additionally, members receive store credit for each predefined amount of merchandise purchased at the retail facility, thus encouraging members to purchase merchandise at the retail facility. Members may be tracked by indicia (e.g., account numbers, names, barcodes, or magnetic/electronic indicia) on CONNOISSEURS CLUB cards provided to members. Members may also be tracked through other indicia stored in the retail facility database (e.g., member name, password, or other tracking number or word). The database may be operated with, e.g., a Microsoft Retail Management System product.

Certain exemplary claims are provided below, although these are not intended to limit the scope or variety of the inventive concepts described herein.

What is claimed is:

1. An evaluation form comprising:
a first rating field containing a first numerical rating provided by a published source, the first numerical rating relating to a product available for purchase at the retail facility;
a second rating field containing a second numerical rating about the product, the second numerical rating being provided by a retail facility;
a note field containing content selected by the retail facility; and
at least one description field containing information.

2. The evaluation form of claim 1, further comprising a blank personal field comprising region for a customer to add written comments about the product.

3. The evaluation form of claim 2, wherein the blank personal field includes a region for the customer to add a third numerical rating.

4. A method of selling wine, comprising providing a card of claims to a customer at the time of purchase.

5. A cabinet for holding and displaying wine, the cabinet comprising:
a plurality of wine storage receptacles;
and for each receptacle; a separate wine bottle display receptacle proximate to the respective receptacle.

6. The cabinet of claim 4, wherein the plurality of storage receptacles are not arranged side-by-side.

7. The cabinet of claims 4, further comprising, for each receptacle, a separate information card display area proximate to the respective receptacle.

8. The cabinet of claim 4, wherein the wine bottles display receptacles display the bottles at an angle.
